(19) United States
(12) Patent Application Publication
(10) Pub. No.: US 2007/0184247 A1
(43) Pub. Date: Aug. 9, 2007

(54) Transparent, super-hydrophobic, disordered composite material

(76) Inventors: John T. Simpson, Clinton, TN (US); Brian R. D'Urso, Clinton, TN (US)

Correspondence Address: UT-Battelle, LLC;Office of Intellectual Property, One Bethal Valley Road, 4500N, MS-6258, Oak Ridge, TN, 37831, US

(21) Appl. No.: 11/347,139

(22) Filed: Feb. 3, 2006

(51) Int. Cl. B32B 3/00; B32B 17/06

(52) U.S. Cl. 428/156; 428/426

(57) ABSTRACT

A super-hydrophobic disordered composite material having a protrusive surface feature includes a recessive phase and a protrusive phase, the recessive phase having a higher susceptibility to a preselected etchant than the protrusive phase, the composite material having an etched surface wherein the protrusive phase protrudes from the surface to form a protrusive surface feature, the protrusive feature being super-hydrophobic, the super-hydrophobic disordered composite material being transparent.

### CROSS-REFERENCE TO RELATED APPLICATION

Specifically referenced are: U.S. patent application Ser. No. 10/900,248 filed on Jul. 27, 2004 by D'Urso and Simpson entitled “Composite, Ordered Material Having Sharp Surface Features”, the entire disclosure of which is incorporated herein by reference; and U.S. patent application Ser. No. 10/900,249 filed on Jul. 27, 2004 by D'Urso and Simpson entitled “Composite, Nanostructured, Super-Hydrophobic Material”, the entire disclosure of which is incorporated herein by reference.

The United States Government has rights in this invention pursuant to contract no. DE-AC05-00OR22725 between the United States Department of Energy and UT-Battelle, LLC.

### FIELD OF THE INVENTION

The present invention relates to differentially etched, super-hydrophobic materials, and more particularly to transparent, differentially etched, super-hydrophobic materials.

### BACKGROUND OF THE INVENTION

The polar nature of water makes it adhesively attractive to most materials including dirt, dust, and glass. Thus, water will normally adhere to glass windows while collecting dirt and dust at the same time. Water drops on a window surface dramatically reduce visibility through windows due to light scattering off the water droplets. In addition, once the water droplets evaporate, the collected dirt and dust form a grimy film on the glass surface. This film reduces optical transparency and gives the glass a dirty appearance. A super-hydrophobic glass surface would repel water drops. This water repellence would dramatically improve window visibility by first eliminating the scattering of light from water droplets on the surface, and secondly by preventing the buildup of surface grime due to droplet evaporation.

### OBJECTS OF THE INVENTION

Accordingly, objects of the present invention include: the provision of a composite, differentially etched, transparent, super-hydrophobic material; and a transparent, self cleaning, super-hydrophobic glass surface. Further and other objects of the present invention will become apparent from the description contained herein.

### SUMMARY OF THE INVENTION

In accordance with one aspect of the present invention, the foregoing and other objects are achieved by a super-hydrophobic disordered composite material having a protrusive surface feature that includes a recessive phase and a protrusive phase, the recessive phase having a higher susceptibility to a preselected etchant than the protrusive phase, the composite material having an etched surface wherein the protrusive phase protrudes from the surface to form a protrusive surface feature, the protrusive feature being hydrophobic, the super-hydrophobic disordered composite material being transparent.

### BRIEF DESCRIPTION OF THE DRAWINGS

FIG. 1 is a photograph showing an overhead view of an embodiment of the invention.

FIG. 1 is a photograph showing an angular view of the embodiment of the invention shown in FIG. 1.

For a better understanding of the present invention, together with other and further objects, advantages and capabilities thereof, reference is made to the following disclosure and appended claims in connection with the above-described drawings.

### DETAILED DESCRIPTION OF THE INVENTION

The present invention provides a cost effective way of making super-hydrophobic optically transparent glass. It is novel in that it combines optical transparency with super-hydrophobicity and the added ability to be anti-reflective. Transparent glass is defined as glass which has the property of transmitting rays of light in such a way that the human eye may see through the glass distinctly.

The present invention is quite similar to the invention described in the patent application “Composite, Nanostructured, Super-Hydrophobic Material” referenced hereinabove with an important exception in that the composition, heat treatment, and etching of the glass have been modified in order to make the feature size smaller so that the material is transparent.

The present invention describes a method of producing transparent superhydrophobic material. The chosen material must have the ability to phase separate into at least two phases (such as a sodium borosilicate glass). These phases should be differentially etchable (i.e. have different etch rates) when subjected to one or more etchants and have a spinodal (i.e. interconnected) structure. The chosen material may need to be heat treated in order to phase separate properly. The surface is then differentially etched to remove one material phase and to sharpen and thin the other phase. The remaining spinodal features are characterized by general dimensions (width, length, height, spacing) in a range of about 4 nm to no more than 500 nm, preferably in a range of about 50 nm to no more than 100 nm. The dimensions of the spinodal features are dependant on a number of factors, such as composition, heat treating duration and temperature, for example.

Smaller feature sizes make the surface more transparent. The processing parameters are heavily dependant on the specific phase separating material used. For example some glasses will phase separate and be spinodal from the initial glass fabrication (no additional heat treating required). Other glasses require many days of specific heat treating to form a phase separated spinodal structure. This dependency on the processing parameters is true for other parameters as well (e.g. etchant type, etchant concentration and etch time). The degree of transparency can often be typically less than optical quality, due to the imposed surface roughness (or porosity) of the features that make the surface super-hydrophobic.

### EXAMPLE I

A sample of EX24 glass (having a composition, in wt %, 65.9 SiO₂, 26.3 B₂O₃, and 7.8 Na₂O) was heat treated for 20 min at 720° C. to induce phase separation, lightly lapped to remove a thin SiO2 crust, and optically polished. The sample was subsequently etched with 5% HF acid for 5 minutes to produce a spinodal and differentially etched surface. The etched surface was coated with a fluorinated self assembled monolayer for 15 min, dried, and then heated for 15 min at 115° C. to ensure thorough bonding of the monolayer to the glass surface. The result was a transparent super-hydrophobic glass having a contact angle in excess of 160 degrees.

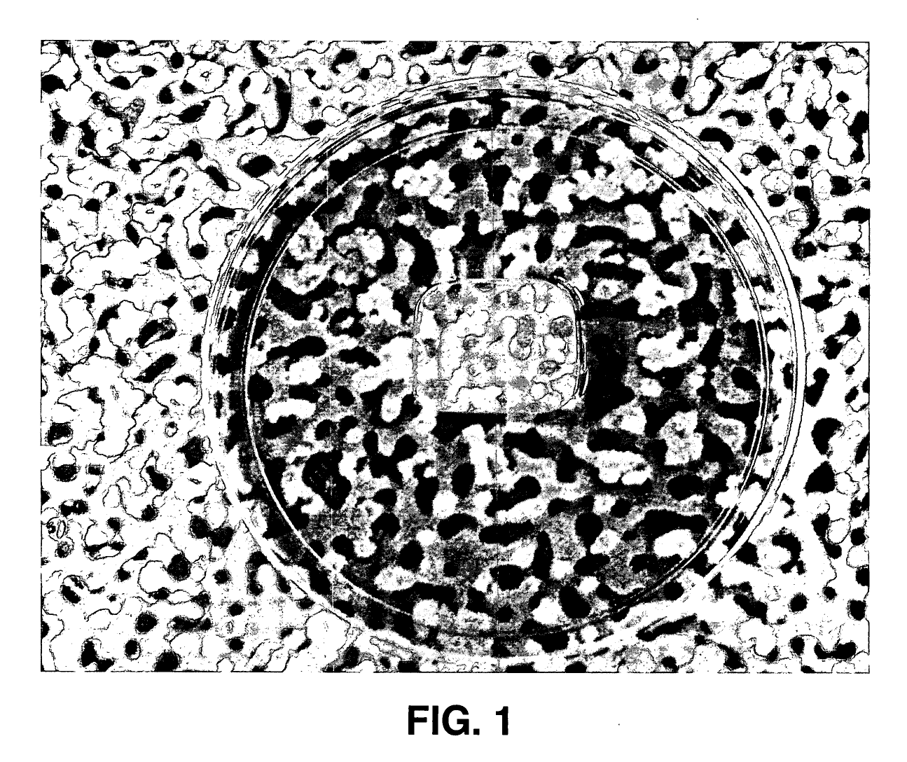

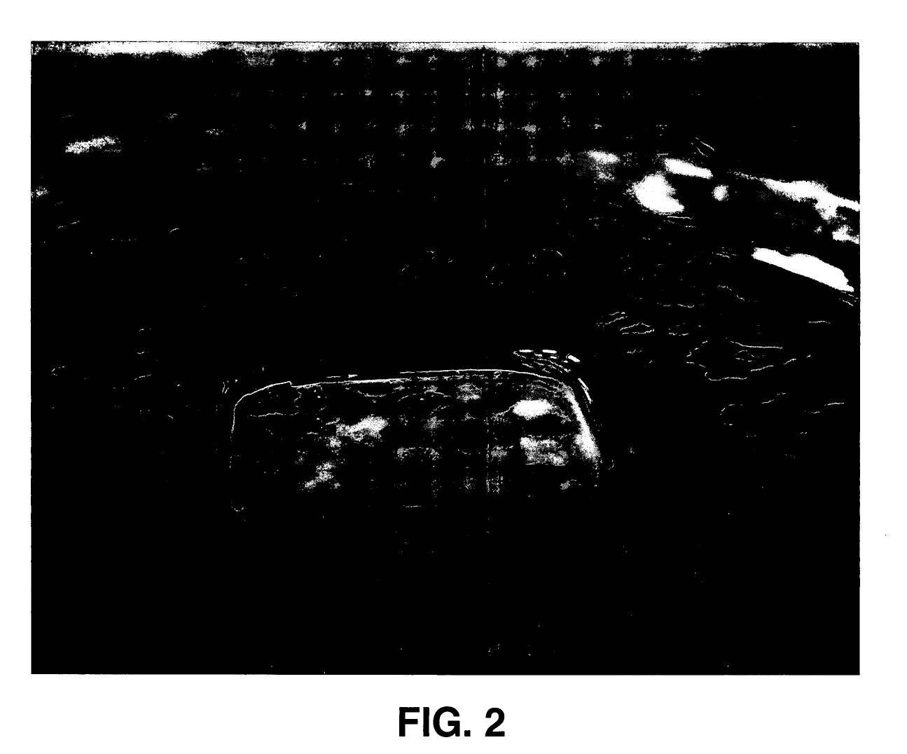

FIGS. 1 and 2 show a sample of roughly rectangular, transparent, super-hydrophobic glass made according to Example I. The sample is in a Petri dish of colored water, and is surrounded by a meniscus. The background is a photograph of a spinodal pattern, which can be clearly seen through the sample.

### EXAMPLE II

A sample of EX24 glass was processed as described in Example I above except for heat treatment, which was carried out for 15 min. at 740° C. The result was transparent and super-hydrophobic glass.

Many variations in glass composition, heat treatment, and etching may yield similar results. The glass may be etched, for example, with hot HCl acid instead of, or in combination with, HF acid.

An antireflective layer generally has two interfaces (i.e. a surface interface and a substrate interface) separated by the thickness of the film. Each interface reflects a certain amount of light. If the substrate reflection returns to the surface such that it is of equal amplitude and out of phase with the surface reflection, the two reflections completely cancel (destructive interference) and the thin film is known as antireflective. The film's thickness determines the reflected phase relationships, while the optical indexes of refraction determine the reflective amplitudes. The etched portion of our super-hydrophobic glass surface has an effective optical index of refraction for an antireflective film, and its thickness can be adjusted by the etch duration to get the correct thickness to produce an antireflective surface. The etched layer will likely have an effective index gradient which would tend to further improve the anti-reflective properties.

While there has been shown and described what are at present considered the preferred embodiments of the invention, it will be obvious to those skilled in the art that various changes and modifications can be prepared therein without departing from the scope of the inventions defined by the appended claims.

What is claimed is:

1. A super-hydrophobic disordered composite material having a protrusive surface feature, said disordered composite material comprising a recessive phase and a protrusive phase, said recessive phase having a higher susceptibility to a preselected etchant than said protrusive phase, said composite material having a differentially etched surface wherein said protrusive phase protrudes from said surface to form a protrusive surface feature, said protrusive feature being hydrophobic, said super-hydrophobic disordered composite material being transparent.

2. A composite material in accordance with claim 1 wherein said recessive phase and said protrusive phase are contiguous and interpenetrating.

3. A composite material in accordance with claim 1 wherein said recessive phase comprises a first material selected from the group consisting of glass, metal, ceramic, polymer, and resin; and wherein said protrusive phase comprises a second material selected from the group consisting of glass, metal, ceramic, polymer, and resin.

4. A composite material in accordance with claim 3 wherein said recessive phase comprises a first glass and said protrusive phase comprises a second glass.

5. A composite material in accordance with claim 1 further comprising a hydrophobic coating on said protrusive surface feature.

6. A composite material in accordance with claim 6 wherein said hydrophobic coating further comprises at least one fluorocarbon.
